(19) United States
(12) Patent Application Publication
(10) Pub. No.: US 2019/0307635 A1
(43) Pub. Date: Oct. 10, 2019

(54) BODY MASSAGE TOOL

(71) Applicant: Victor SULTANA, Carlton (AU)

(72) Inventor: Victor SULTANA, Carlton (AU)

(21) Appl. No.: 16/376,323

(22) Filed: Apr. 5, 2019

(30) Foreign Application Priority Data
Apr. 5, 2018 (AU) 2018901130

(51) Int. Cl. A61H 15/00; A61H 7/00

(52) U.S. Cl. CPC A61H 15/0092; A61H 2201/0157; A61H 2015/005; A61H 7/003

(57) ABSTRACT

A massage tool comprised of a single member having two handles joined by a spine, the tool so shaped so that it can be used to massage any part of the body. The tool can be used on its own or can be placed between a surface (for example, a wall or floor) and that part of the body to be massaged. The tool provides insertion points to which massage devices (for example, massage balls) can be attached. The shape of the member enables it to be rotated in a ‘lever action’—a back and forth rotation which, in concert with pressure applied from the human body to the member, effects a massage to that part of the body.

### FIELD OF THE INVENTION

The present invention relates to the field of massage tools. More specifically the invention relates to the field of portable massage tools that can be used to massage different parts of the body.

### BACKGROUND TO THE INVENTION

Various massage tools are known in the prior art. There are tools that are portable so that they can easily be carried with the user in a bag or other casing. Such portable tools are usually designed to massage a specific part of the body, for example, the head, neck, back or feet, Tools that can massage multiple parts of the body sacrifice simplicity. For example a tool may consist of many parts which must be assembled and used in a particular way.

There is thus a need for a simple massage tool that can be easily adapted to be able to be used to massage different parts of the body. It is an object of the present invention to provide such a tool or at least to provide the public with a useful alternative.

### SUMMARY OF THE INVENTION

In one form of the invention there is proposed a massage tool comprising two handles joined by a longitudinal spine and a plurality inserts located along the spine and adapted to be engaged by a massaging implement through a correspondingly shaped insert.

In preference at least one insert may be positioned on the handle.

In preference the tool includes transverse corrugations located on at least one handle

In preference the massaging implements are in the shape of a ball and include a screw adapted to engage the inserts that include threads.

It should be noted that any one of the aspects mentioned above may include any of the features of any of the other aspects mentioned above and may include any of the features of any of the embodiments described below as appropriate.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows.

FIG. 1 is a top view of the massage tool according to an embodiment of the present invention;

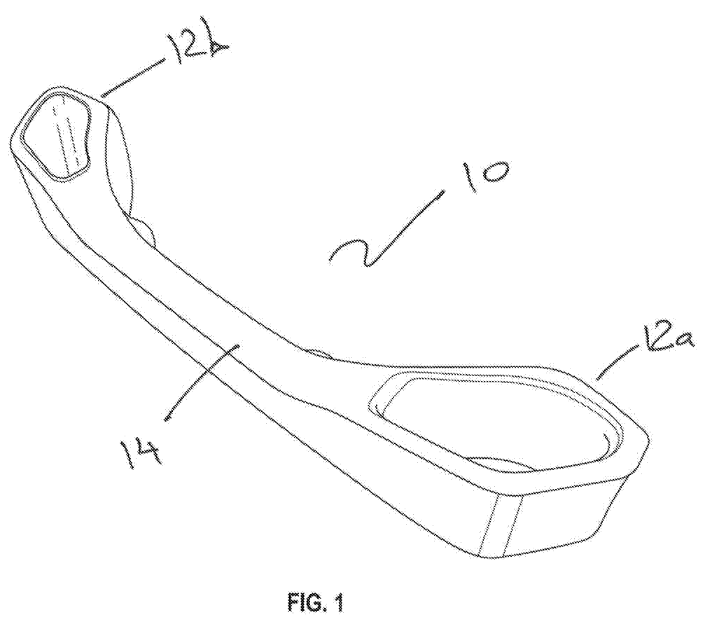

FIG. 2 is a bottom view of the massage tool; and

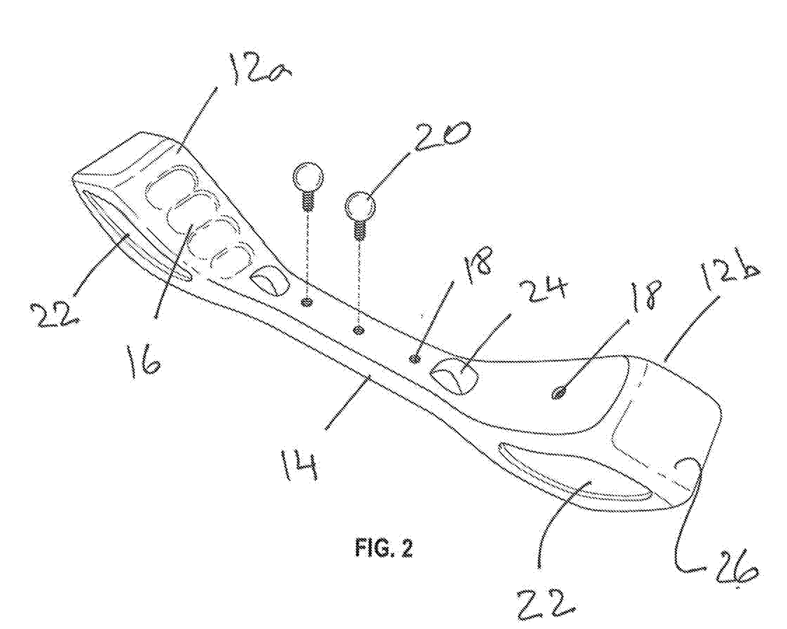

FIG. 3 is a side view of the massage tool.

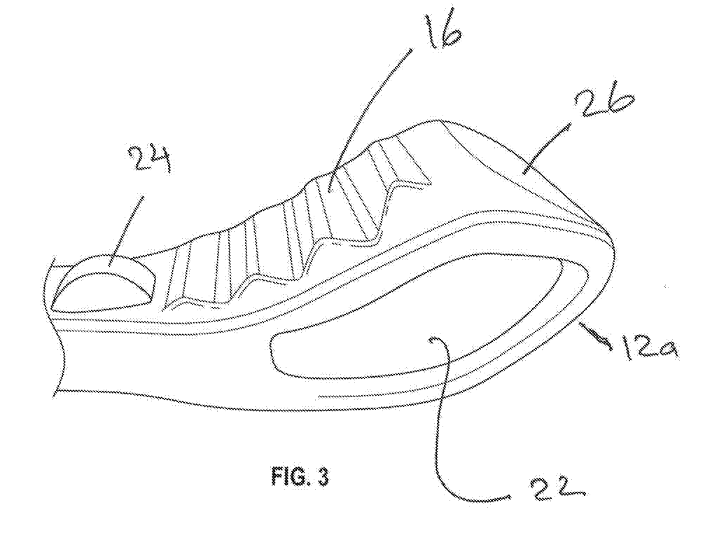

### DETAILED DESCRIPTION OF THE INVENTION

The following detailed description of the invention refers to the accompanying drawings. Wherever possible, the same reference numbers will be used throughout the drawings and the following description to refer to the same and like parts. Dimensions of certain parts shown in the drawings may have been modified and/or exaggerated for the purposes of clarity or illustration.

Turning to the drawings now in detail there is illustrated in the figures a single member massage tool 10 including handles 12a and 12b connected via a longitudinal spine 14. The length of the tool may vary but is typically of the order of some 40 to 50 cm with the handles being wider than the spine.

Located on handle 12a are transverse corrugations 16 whilst along the spine 14 are threaded inserts 18. The threaded inserts are adapted to accommodate massage balls 20 having screws that engage inserts 18. There are multiple inserts along the spine an insert on handle 12b allowing the user to determine where to attach the massage balls. Of course it is to be understood that the massage tool 10 may include corrugations on both handles and equally well threaded inserts.

Longitudinal pads 24 are located between the handles and the spine 14.

In order to be able to hold the tool the handles include aperture 22 that allow the user to manipulate the tool using their hands or feet. Each handle may also include a flat surface 26 that enables the tool to be placed between a human body and some other surface (for example, a table or a wall).

The tool is of a slight concave shape with the handles bending upwards from the spine. The shape of the handle consists of smooth curves on its top and bottom surfaces making it suitable to be placed against a human body for the purposes of providing a massage,

The whole tool may be moulded by using suitable plastic material although it may equally be made from other materials,

The invention generally provides a massage tool comprised of a single member which is easily portable and can be used to massage any part of the body. Massage devices can be attached to the member to assist with the provision of the massage.

The reader will now appreciate the present invention which provides a portable massage tool which can be used to massage any part of the body.

The shape of the tool provides a ‘lever action’, that is the ability to put pressure by the human body on the device and enable it to be rotated against the surface 26, This ‘lever action’ can be used to provide a massage to that part of the human body.

The use of the massage tool is not limited to providing massages by way of ‘lever action’.

Many variations of the tool may be provided whilst still falling within the scope of the invention. For example while the above embodiment disclosed the use of screws to engage a threaded insert, the engagement may very well be a straight fit, a snap-type lock fit or simply a frictional engagement,

Furthermore illustrated are massage balls and it is to be understood that the shape of them may not be limited to a ball but may take on other shapes such as a cylindrical shape. There may also be provided a massage Implement that may engage more than one insert at the same time.

### LIST OF COMPONENTS

The drawings include the following integers.
massage tool 10
handles 12a,b
spine 14
corrugations 16
threaded inserts 18
massage balls 20
apertures 22
pads 24
surface 26

Further advantages and improvements may very well be made to the present invention without deviating from its scope. Although the invention has been shown and described in what is conceived to be the most practical and preferred embodiment, it Is recognized that departures may be made therefrom within the scope of the invention, which is not to be limited to the details disclosed herein but is to be accorded the full scope of the claims so as to embrace any and all equivalent devices and tool. Any discussion of the prior art throughout the specification should in no way be considered as an admission that such prior art is widely known or forms part of the common general knowledge in this field.

In the present specification and claims (if any), the word “comprising” and its derivatives including “comprises” and “comprise” include each of the stated integers but does not exclude the inclusion of one or more further integers.

1. A massage tool comprising;
two handles joined by a longitudinal spine;
a plurality Inserts located along the spine and adapted to be engaged by a massaging implement through a correspondingly shaped insert.

2. A massage tool as in claim 1 wherein at least one insert may be positioned on the handle.

3. A massage tool as in claim 1 further including transverse corrugations located on at least one handle

4. A massage tool as in claim 1 wherein massaging implements are in the shape of a ball and include a screw adapted to engage the inserts that include threads.
